(19) United States
(12) Patent Application Publication
(10) Pub. No.: US 2003/0045192 A1
(43) Pub. Date: Mar. 6, 2003

(54) Rigidified nonwoven and method of producing same

(75) Inventors: David Grant Midkiff, Alpharetta, GA (US); Michael Lawrence Gross, Atlanta, GA (US); Billy Dean Arnold, Alpharetta, GA (US); Sandy Chi-Ching Tan, Roswell, GA (US)

Correspondence Address: William W. Letson, Kimberly-Clark Worldwide, Inc., Patent Department, 401 North Lake Street, Neenah, WI, 54956, US

(73) Assignee: Kimberly-Clark Worldwide

(21) Appl. No.: 09/944,435

(22) Filed: Aug. 31, 2001

(51) Int. Cl. B32B 3/06; B32B 5/02; B32B 9/00; D06N 7/04

(52) U.S. Cl. 442/103; 442/340; 442/417; 442/381; 442/149; 428/152

(57) ABSTRACT

The present invention relates to a composite structure which is capable of use as a filter medium and a method for producing the same. The composite structure contains at least a first nonwoven layer, said first layer having a first surface and a second surface, as well as a rigidifying or stiffening component. The rigidifying component is applied in semi-molten state to the one surface of the nonwoven layer and provides sufficient stiffness and/or resilience to the composite such that the composite is self-pleatable yet retains flexibility. The rigidifying or stiffening component may be filaments of a polymer or polymer blend or alternatively the rigidifying or stiffening component may also be a wax or wax blend.

### BACKGROUND OF THE INVENTION

The present invention is related to a filter medium for fluids, and more particularly related to a nonwoven web highly suitable for fluid filter media.

Different types of nonwoven webs have been used as filter media for various liquid and gas filtration applications, and such nonwoven webs include meltblown fiber webs, solution spun fiber webs, wet-laid fiber webs, carded fiber webs, air-laid fiber webs and spunbond fiber webs. Of these nonwoven fiber webs, microfiber nonwoven webs, such as meltblown fiber webs, have been widely employed as fine particle filter media since the densely packed fine fibers of these webs provide fine interfiber pore structures that are highly suitable for mechanically trapping or screening fine particles and therefore are conducive for providing a high filter efficiency. However, the fine pore structure of meltblown fiber webs and other similar webs having densely packed fine fibers results in a low permeability, creating a high pressure drop across the webs. Consequently, the low permeability of fine fiber filter media requires the application of a high driving pressure to establish an adequate throughput rate across the filter media. Furthermore, as contaminants accumulate on or in the surface of the filter media, the contaminants quickly clog the small interfiber pores, further reducing the permeability of the media, increasing the pressure drop across the media and rapidly shortening their service-life. In contrast, filter media with large interfiber pores and thus a high permeability, which contain sparsely packed and typically thick fibers, require a relatively low driving pressure to provide an adequate throughput rate and extended service-life. However, highly permeable filter media, e.g., fiberglass HVAC filters, suffer from a low filter efficiency in that the large interfiber pore structures of the media do not provide interstitial configurations that are suitable for entrapping fine contaminant particles.

In addition to the low permeability, microfiber webs typically do not have high physical strength. Thus, in general, composite filter media are formed by laminating at least one layer of a microfiber web onto a highly porous supporting layer or between two highly porous supporting layers since the microfiber layer does not have sufficient physical strength to be self-supporting. For example, U.S. Pat. No. 4,589,894 to Gin et al. discloses a vacuum cleaner filter bag that is produced from a laminate of a fine fiber nonwoven layer and two highly porous nonwoven support layers. Consequently, the typical production process for composite filter media requires not only different layer materials but also requires elaborate layer forming and laminating steps, making the filter media costly. Although self-supporting single-layer microfiber filter media can be produced in order to avoid the complexity of forming composite filter media by increasing the thickness of the microfiber filter layer, the pressure drop across such thick microfiber filter media is unacceptably high, making the microfiber media unfit for filter applications, especially for high throughput filter applications. An additional disadvantage of existing microfiber filter media and laminate filter media containing microfiber webs is that they tend to exhibit weak physical properties. Consequently, these filter media are not particularly useful for large volume liquid filtration uses. Other sheet filter media widely used in the industry are cellulosic fiber webs of thermomechanically or chemically processed pulp fibers. Cellulosic fiber media are, for example, commonly used in automotive oil and fuel filters and vacuum cleaner filters. However, cellulosic fiber filter media tend to have a limited filter efficiency and do not provide the high strength properties that are required for high pressure, large volume liquid filtration applications unless the additional step of saturating the paper with a cross-linking solution is taken, followed by curing the cross-linking agent.

Yet another group of filter media that have been utilized in liquid filtration applications are calendered spunbonded nonwoven webs, especially polyester spunbond webs. For example, calendered polyester spunbond filter media are commercially available from Reemay, Inc. under the Reemay® trademark. Typically, such spunbond filter media are formed by solution spinning a physical blend of structural polymers and solvent, randomly and isotropically depositing the filaments onto a forming surface to form a nonwoven web, calendering the nonwoven web to effect adhesive bonds, and removing the solvent, thereby forming a sheet filter medium that has a relatively uniform thickness. These calendered sheet filter media exhibit good strength properties. However, the filter efficiency of these spunbond filter media is, in general, significantly lower than that of microfiber filter media. In addition, the porosity distribution on the surface of the calendered spunbond filter media tends to be non-uniform. This is because when the spun filaments are randomly deposited on the forming surface, the filament density, i.e., the number of filament strands deposited for a given area of surface, of the deposited web varies from one section to another; and when the deposited fiber web is calendered and compacted to a uniform thickness, the sections of high fiber density and low fiber density form low porosity and high porosity sections, respectively. Consequently, the calendered spunbond filter media tend to have a non-uniform porosity distribution. Although filter media produced from nonwoven webs of coarser fibers, such as spunbond fiber webs and commonly-available staple fiber webs, have been used in filtration applications such as stove hood filters, they have not been used as filter media for fine particles. This is because, as mentioned above, the thickness of these coarse fibers causes the nonwoven webs to have larger interfiber pores than those of microfiber webs at a given basis weight, and consequently, nonwoven webs of spunbond fibers and staple fibers have not been used in fine particles filtration applications, except as means to provide support for fine fiber webs. However, in order to maintain the pleats in the webs where the large fibers are used as support for the fine fiber webs, an additional step of heating the spunbond material is required.

More specifically, traditional HVAC filters are produced using polyester or polypropylene filter media that require the support of an expanded metal backing. The expanded metal, when adhered to the nonwoven filter, helps in the retention of pleats following the mechanical deformation of the pleating process. Typically the pleating process is done at room temperature. Nonwoven filter media are typically pliable, soft and will not retain a pleated form without the expanded metal backing. The disadvantages of using expanded metal are: 1) short roll lengths, which require frequent changes and line down time; 2) sharp edges; 3) a separate lamination step; and 4) additional cost. One way to simplify the filter pleating process is to produce a filter medium that is self-pleatable or that can be pleated without the use of expanded metal.

There remains a need for economical filter media that provide a highly desirable combination of high filtration efficiency, low pressure drop, capacity and high physical strength without the need to be laminated to a support material. Said another way, there is a need for self-supporting filter media that provide combinations of desirable filtration properties, including high filtration efficiency, high permeability, low pressure drop, high throughput, long service-life and self-supporting strength.

### SUMMARY OF THE INVENTION

This invention relates generally to a nonwoven fabric or web which is formed from spunbond fibers of a thermoplastic resin and laminates using such a web as a component. The fabric has a high stiffness and may be used as a filter. Thermoplastic resins have been extruded to form fibers, fabrics and webs for a number of years. The most common thermoplastics for this application are polyolefins, particularly polypropylene. Other materials such as polyesters, polyether esters, polyamides and polyurethanes are also used to form nonwoven spunbond fabrics. Nonwoven fabrics or webs are useful for a wide variety of applications such as components of diapers, feminine hygiene products, towels, recreational or protective fabrics and as geotextiles and filter media. The nonwoven webs used in these applications may be simply spunbond fabrics but are often in the form of nonwoven fabric laminates like spunbond/spunbond (SS) laminates or spun bond/meltblown/spunbond (SMS) laminates. As filter media, some of the desired characteristics of nonwoven fabrics are that they be permeable to the fluid being filtered yet have a high filtration efficiency. Permeability to the fluid being filtered is quite important as low permeability could result in a high pressure drop across the filter requiring a higher, and hence more costly, energy input into the filtered fluid and shortening filter life. Low permeability could also result in physical damage to the filter upon being clogged with filtered particles because of increased pressure drop across the filter. High filtration efficiency is, of course, the main purpose for a filter and great efficiency and ability to maintain the efficiency at an acceptable level are key to filter performance. In many applications, filtration materials are required which have structural integrity by themselves and can be converted into various shapes and which will then hold that shape. This convertibility is often aided by stiffening the filter medium. The stiff filter media can be made into a pleated shape which gives far more surface area for filtration than a non-pleated shape in the same space.

Specifically, the present invention provides a composite structure which is capable of use as a filter medium. The composite structure contains at least a first nonwoven layer, said first layer having a first surface and a second surface, as well as a rigidifying or stiffening component. The rigidifying component is applied to the one surface of the nonwoven layer and provides sufficient stiffness and/or resilience to the composite such that the composite is self-pleatable yet retains flexibility. In some instances, as discussed in more detail below, the rigidifying component will be or become integrated in the web as a result of melt wicking. The rigidifying or stiffening component may be applied as molten filaments of a wax, wax blended with a polymer or plastomer, polymer, polymer blend or a blend of polymers, said filaments not being limited in cross-sectional shape, and having a diameter of about 0.004 inches or larger and desirably having a diameter of about 0.040-0.12 inches. The rigidifying or stiffening component may further comprise a filler material, such as CaCO₃, TiO₂, carbon black, starch and/or clay or many other commercially known filler or combination of fillers, to break up the structure of the fiber or wax so as to allow it to have better folding or pleating characteristics. The rigidifying component may be selectively applied by any known means and in essentially any pattern provided that sufficient rigidifying component is present to achieve the necessary or desired bonding and thus the desired or necessary rigidity or stiffness; provided, however, that the rigidifying component desirably should be applied so as to minimize the effect of the component's presence on the filtration efficiency and pressure drop of the composite, where the composite is part of a filter media. It should be noted that while the rigidifying component is typically added to the surface of a nonwoven layer, that since the rigidifying component is typically in a liquid or molten form when applied that it will often become integrated into the nonwoven layer itself as a result of the melt wicking which occurs. That is, since the rigidifying component is in a liquid or molten condition when applied it will wick in and wet the fibers of the nonwoven material before solidifying. In one or more embodiments of the present invention the rigidifying component may contain a filler in an amount between about 10 to about 80% by weight, and desirably in an amount between about 30 to about 50% by weight.

The present invention may further include a second nonwoven layer. In one embodiment, the second nonwoven layer may be applied adjacent to the first nonwoven layer. Alternatively, the second nonwoven layer may be applied to the rigidifying component so the rigidifying component is positioned between the first and second nonwoven layers. In any of the embodiments of the invention, the rigidifying component may be applied to the top or bottom surface of the nonwoven layer, and may even be applied between the layers of the nonwoven (where more than one present) to serve as a support in addition to acting in the retention of the pleat shape. While it is desired in the present invention that the number of nonwoven layers be kept to a minimum, the present invention also contemplates the incorporation of any number of nonwoven layers in the composite, provided the desired characteristics can be obtained.

In the embodiments of the present invention where multiple layers of nonwoven materials are used in the composite, the rigidifying or stiffening component may be used to adhere the nonwoven layers to each other in addition to making the composite self-supporting. The rigidifying component may be adhesive. That is, the rigidifying component may have an adhesive component blended into the molten polymer application.

The nonwoven layers of the present invention may be comprised of a spunbond web, bicomponent spunbond web, meltblown web, coformed web or bonded carded web and the filaments thereof may have a variety of cross-sectional shapes, including asymmetrical cross-sectional shapes. The shape of the filaments of the nonwoven material are selected to provide desired web stiffness and fold retention in the composite.

The present invention is also directed to a method of producing a composite material adapted for filtration. The method of the present invention includes the steps of providing a first layer of nonwoven material; providing a stiffening or rigidifying component; applying the molten rigidifying component to one surface of the first layer of nonwoven material; such that the rigidifying component provides the nonwoven material with sufficient rigidity so as to create a rigid yet pleatable material. The method of the present invention may also include the steps of providing a second layer of nonwoven material; applying the rigidifying component to one surface of the first layer of nonwoven material; and applying the second layer of nonwoven material to the rigidifying component; such that the rigidifying component bonds the layers of nonwoven material together. In another embodiment, the method of the present invention may further include the steps of providing a second layer of nonwoven material; and applying the second layer of nonwoven material to the first nonwoven layer, wherein the rigidifying component may be applied to either or both the first or second layer of nonwoven material.

The method of the present invention may also include the step of selectively applying the rigidifying component to the nonwoven material. Other embodiments of the present invention may also include the step of folding or pleating the media. It is further contemplated that the nonwoven material of the present invention may be formed in-line or off-line.

### BRIEF DESCRIPTION OF THE DRAWINGS

FIG. 1 shows a cross-sectional view of one embodiment of the present invention.

FIGS. 2a and 2b and 2c show top views of the present invention wherein the rigidifying component is a filament.

FIGS. 3a and 3b are exemplary views of shaped fibers which may be used as the rigidifying component of the present invention.

FIG. 4 shows a cross-sectional view of one embodiment of the present invention having multiple nonwoven layers.

FIG. 5 shows a cross-sectional view of a second embodiment of the present invention having multiple nonwoven layers.

FIG. 6 is a schematic diagram of a bicomponent spunbond web forming process which can be used to produce a nonwoven layer of the present invention.

FIG. 7 shows a cross-sectional view of a third embodiment of the present invention having multiple nonwoven layers.

FIG. 8 is a schematic diagram of an electretizing process suitable for the present invention.

### DEFINITIONS

As used herein, the term “biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. No. 5,108,827 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein the term “blend” means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

As used herein and in the claims, the term “comprising” is inclusive or open-ended and does not exclude additional unrecited elements, compositional components, or method steps.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. The fibers may also have shapes such as those described in U.S. Pat. Nos. 5,277,976 to Hogle et al., and 5,069,970 and 5,057,368 to Largman et al., hereby incorporated by reference in their entirety, which describe fibers with unconventional shapes.

As used herein, the term “liquid” means a non-particulate substance and/or material that flows and can assume the interior shape of a container into which it is poured or placed.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “compaction roll” means a set of rollers above and below the web to compact the web as a way of treating a just produced spunbond web in order to give it sufficient integrity for further processing, but not the relatively strong bonding of secondary bonding processes like through-air bonding, thermal bonding and ultrasonic bonding. Compaction rolls slightly squeeze the web in order to increase its self-adherence and thereby its integrity. Compaction rolls perform this function well but have a number of drawbacks. One such drawback is that compaction rolls do indeed compact the web, causing a decrease in bulk or loft in the web which may be undesirable for the use desired. A second and more serious drawback to compaction rolls is that the web will sometimes wrap around one or both of the rollers, causing a shutdown of the web production line for cleaning of the rollers, with the accompanying obvious loss in production during the down time. A third drawback of compaction rolls is that if a slight imperfection is produced in formation of the web, such as a drop of polymer being formed into the web, the compaction roll can force the drop into the foraminous belt, onto which most webs are formed, causing an imperfection in the belt and ruining it.

The term “electretized” as used herein indicates the condition in which a nonwoven medium is electret treated to hold permanent electrostatic charges.

As used herein, the term “hot air knife” or “HAK” means a process of pre- or primarily bonding a just produced spunbond web in order to give it sufficient integrity, i.e. increase the stiffness of the web, for further processing, but does not mean the relatively strong bonding of secondary bonding processes like TAB, thermal bonding and ultrasonic bonding. A hot air knife is a device which focuses a stream of heated air at a very high flow rate, generally from about 1000 to about 10000 feet per minute (fpm) (305 to 3050 meters per minute), or more particularly from about 3000 to 5000 feet per minute (915 to 1525 m/min.) directed at the nonwoven web immediately after its formation. The air temperature is usually in the range of the melting point of at least one of the polymers used in the web, generally between about 200 and 550° F. (93 and 290° C.) for the thermoplastic polymers commonly used in spunbonding. The control of air temperature, velocity, pressure, volume and other factors helps avoid damage to the web while increasing its integrity. The HAK's focused stream of air is arranged and directed by at least one slot of about ⅛ to 1 inches (3 to 25 mm) in width, particularly about ⅜ inch (9.4 mm), serving as the exit for the heated air towards the web, with the slot running in a substantially cross-machine direction over substantially the entire width of the web. In other embodiments, there may be a plurality of slots arranged next to each other or separated by a slight gap. The at least one slot is usually, though not essentially, continuous, and may be comprised of, for example, closely spaced holes. The HAK has a plenum to distribute and contain the heated air prior to its exiting the slot. The plenum pressure of the HAK is usually between about 1.0 and 12.0 inches of water (2 to 22 mmHg), and the HAK is positioned between about 0.25 and 10 inches and more preferably 0.75 to 3.0 inches (19 to 76 mm) above the forming wire. In a particular embodiment the HAK plenum's cross sectional area for cross-directional flow (i.e. the plenum cross sectional area in the machine direction) is at least twice the total slot exit area. Since the foraminous wire onto which spunbond polymer is formed generally moves at a high rate of speed, the time of exposure of any particular part of the web to the air discharged from the hot air knife is less than a tenth of a second and generally about a hundredth of a second in contrast with the through air bonding process which has a much larger dwell time. The HAK process has a great range of variability and controllability of many factors such as air temperature, velocity, pressure, volume, slot or hole arrangement and size, and the distance from the HAK plenum to the web.

As used herein, the term “machine direction” or MD means the length of a web in the direction in which it is produced. The term “cross machine direction” or CD means the width of web, i.e. a direction generally perpendicular to the MD.

As used herein the term “meltblown fibers” means fibers formed by extruding a molten thermoplastic material through a plurality of fine, usually circular, die capillaries as molten threads or filaments into converging high velocity, usually hot gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin. Meltblown fibers are microfibers which may be continuous or discontinuous, are generally smaller than 10 microns in average diameter (using a sample size of at least 10), and are generally tacky when deposited onto a collecting surface.

As used herein the term “microfibers” means small diameter fibers having an average diameter not greater than about 75 microns, for example, having an average diameter of from about 0.5 microns to about 50 microns, or more particularly, microfibers may have an average diameter of from about 2 microns to about 40 microns. Another frequently used expression of fiber diameter is denier, which is defined as grams per 9000 meters of a fiber and may be calculated as fiber diameter in microns squared, multiplied by the density in grams/cc, multiplied by 0.00707. A lower denier indicates a finer fiber and a higher denier indicates a thicker or heavier fiber. For example, the diameter of a polypropylene fiber given as 15 microns may be converted to denier by squaring, multiplying the result by 0.89 g/cc and multiplying by 0.00707. Thus, a 15 micron polypropylene fiber has a denier of about 1.42 (15 2×0.89×0.00707=1.415). Outside the United States the unit of measurement is more commonly the “tex”, which is defined as the grams per kilometer of fiber. Tex may be calculated as denier/9.

As used herein the term “monocomponent” fiber refers to a fiber formed from one or more extruders using only one polymer. This is not meant to exclude fibers formed from one polymer to which small amounts of additives have been added for coloration, anti-static properties, lubrication, hydrophilicity, etc. These additives, e.g. titanium dioxide for color, are generally present in an amount less than 5 weight percent and more typically about 2 weight percent.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include but are not limited to isotactic, syndiotactic and random symmetries.

As used herein the term “self-pleatable” or “self-pleating” refers to a media which is capable of retaining a pleat without the need for additional materials or structure. A self-pleatable or self-pleating media is one which need not be reinforced to retain its shape once it is pleated. That is, for example, a self-pleating or self-pleatable filter is a filter which is self-sustaining or self-supporting in such a manner that it need not be reinforced with any additional materials or structure (e.g. metal backing) to retain pleats which are created therein. The term “self-pleatable” of “self-pleating” is not intended to suggest that the material in which it is used in connection with is capable of pleating without external force.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,602,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 20 microns.

The term “staple fibers” refers to discontinuous fibers, which typically have an average diameter similar to or some-what smaller than that of spunbond fibers. Staple fibers are produced with a conventional fiber spinning process and then cut to a staple length, from about 1 inch to about 8 inches. Such staple fibers are subsequently carded or air-laid and thermally bonded to form a nonwoven web.

As used herein “thermal point bonding” involves passing a fabric or web of fibers to be bonded between a heated calender roll and an anvil roll. The calender roll is usually, though not always, patterned in some way so that the entire fabric is not bonded across its entire surface and the anvil is usually flat. As a result, various patterns for calender rolls have been developed for functional as well as aesthetic reasons. One example of a pattern is the Hansen Pennings or “H&P” pattern with between about a 5 and 50% bond area with between about 50-3200 bonds/square inch as taught in U.S. Pat. No. 3,855,046 to Hansen and Pennings. One example of the H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). Another typical point bonding pattern is the expanded Hansen Pennings or “EH P” bond pattern which produces about a 15% bond area with a square pin having a side dimension of 0.037 inches (0.94 mm), a pin spacing of 0.097 inches (2.464 mm) and a depth of 0.039 inches (0.991 mm). Another typical point bonding pattern designated 714″ has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds and a wire weave pattern looking as the name suggests, e.g. like a window screen. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

As used herein, “through air bonding” or “TAB” means a process of bonding a nonwoven conjugate fiber web in which air which is sufficiently hot to melt one of the polymers of which the fibers of the web are made is forced through the web. The air velocity is between 100 and 500 fpm (30-152 m/min.) and the dwell time may be as long as 60 seconds. The air temperature may be between about 230 and 325° F. (110162° C.), depending on the melting points of the polymers used. The melting and resolidification of the polymer provides the bonding. Through air bonding is generally regarded a second step bonding process, and since TAB requires the melting of at least one component to accomplish bonding, it is restricted to webs with at least two components like conjugate fibers or those which include an adhesive.

As used herein, “ultrasonic bonding” means a process performed, for example, by passing the web between a sonic horn and anvil roll as illustrated in U.S. Pat. No. 4,374,888 to Bornslaeger.

### DETAILED DESCRIPTION OF THE INVENTION

In response to the discussed difficulties and problems encountered in the prior art a new method and composite for making a self-pleatable media has been discovered. The composite not only is self-supporting, but is also capable of being pleated and retaining the pleats which may be optionally added thereto.

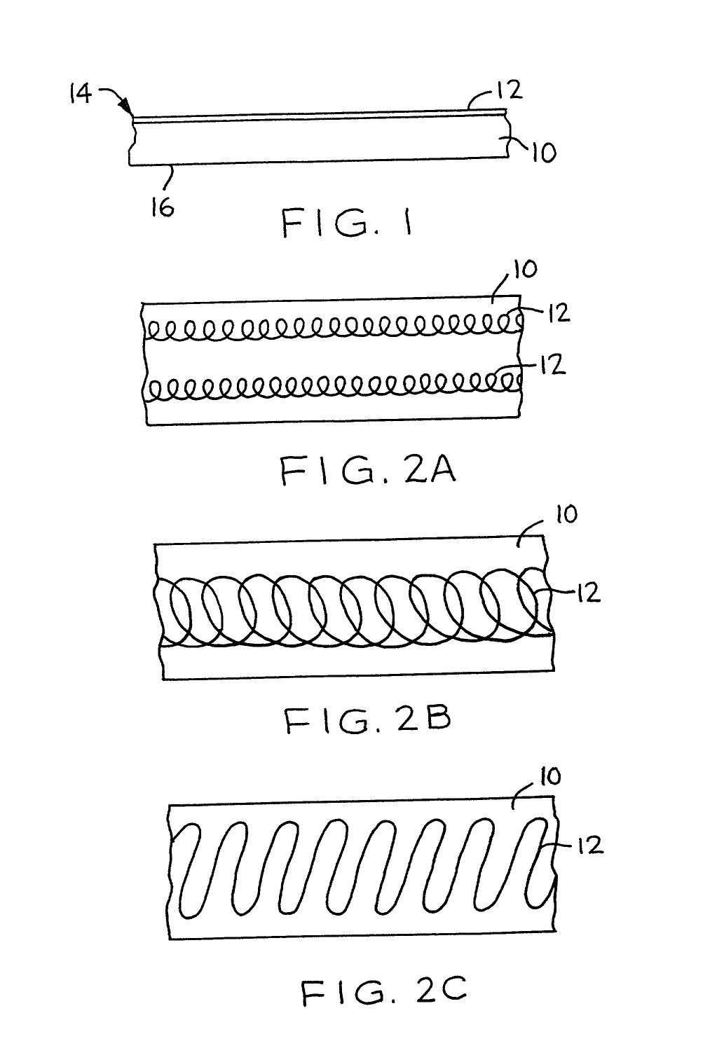

The present invention provides a composite structure comprising a first nonwoven layer 10 and a rigidifying component 12. The rigidifying component 12 is applied to the nonwoven material 10. The first nonwoven layer 10 has a first surface 14 and a second surface 16. The rigidifying component 12 provides sufficient stiffness and/or resilience to the composite such that the composite is self-pleatable yet retains flexibility. As illustrated in FIG. 2, the rigidifying or stiffening component 12 may be filaments of a polymer or polymer blend, said filaments not being limited in cross-sectional shape, and having a diameter of about 0.004 inches or larger and desirably having a diameter of about 0.040-0.12 inches. The rigidifying or stiffening component may also be a wax or wax blend. If a wax or wax blend is selected for use in the present invention, desirably, the wax or wax blend will have a melt temperature of at least about 160° F. (27° C.) such that the wax or wax blended will be capable of exposure to extreme conditions frequently experienced during transport and storage of the media before use. Suitable waxes include those available from Blended Waxes, Inc., a company doing business in Oshkosh, Wis. The use of a rigidifying component (e.g. polymers or waxes) with sufficiently high melt temperatures will avoid or reduce the breakdown of the filaments or waxes and/or the undesired spreading of the rigidifying component after application to the composite, thereby maintaining the self-pleatablability, efficiency and pressure drop characteristics which are desired. Additionally, the rigidifying component (e.g. polymers or waxes) selected will also be resistant to cracking or breaking away from the nonwoven layer or layers when exposed to extreme cold temperatures or when they nonwoven material is pleated. Where it is known that the composite will not be exposed to extreme temperatures, the filaments or waxes selected need only have those characteristics necessary to achieve the desired results of the present invention.

Suitable rigidifying components include, but are not limited to, paraffin waxes, paraffin wax blended with other suitable plastomers, polymers, polypropylene, polyethylene, nylon, polyesters, etc., and blends thereof. One skilled in the art will recognize that the suitable rigidifying components can have various molecular weight distributions. The rigidifying or stiffening component may further comprise a filler material, such as CaCO₃ or any other suitable commercially known filler, to break up the structure of the rigidifying component so as to allow rigidifying component to exhibit better folding or pleating characteristics. That is, the rigidifying component may adhere to the nonwoven layer or layers of the composite and hold a pleated or folded form without experiencing significant relaxation, especially at or near the folds or pleats, where a filler is used in the rigidifying component. More specifically, where a filler is not included in the rigidifying component, the polymers of the component are closely spaced and the force which is distributed throughout component upon pleating is evenly distributed which may keep the polymer from experiencing forces which go up to or beyond the tensile yield point of the component, thereby allowing the component to experience elastic behavior or creep and attempt to return to its original unpleated form. The inclusion of a filler, such as calcium carbonate, in the rigidifying component creates a polymer which has a macrostructure which is more discontinuous in nature. When a filament containing such a filler is bent (as occurs in the filter media pleating process), there is less polymer in the bend area due to the presence of the filler. This results in a higher bending force being applied to the polymer on a per unit volume basis at the bend. This higher bending force on the polymer creates higher stress on the polymer, which more effectively exceeds the tensile yield point of the polymer, thereby resulting in a more permanent deformation. The percentage of filler, desirably calcium carbonate, in the polymer will change the final material properties of the filament. Too much filler can cause the filament to be too brittle and break during pleating (i.e. excessive application of stress beyond the polymer's tensile yield point). Conversely, too little filler causes the filament to “creep” or recover its original shape due to stress relaxation after pleating (i.e. insufficient application of stress to attain deformation beyond the polymer's tensile yield point). Accordingly, it is desired that the filaments of the present invention contain calcium carbonate filler in an amount of about 10 to about 80% by weight, and more desirably between about 30 to about 50% by weight.

The rigidifying component may be selectively applied by any known means and in essentially any pattern provided that sufficient rigidifying component is present to achieve the necessary or desired bonding (with the nonwoven material) and thus the desired or necessary rigidity or stiffness; provided, however, that the rigidifying component desirably should be applied so as to minimize the effect of the component's presence on the filtration efficiency and pressure drop of the composite, where the composite is a filter or is a or is part of a filter media. One embodiment of the present invention contemplates the use of a stationary die or extruder which will result in the application of the rigidifying component in the machine direction of the nonwoven layer or layers. Another embodiment of the present invention contemplates the use of a reciprocating filament forming head or wax applicator for approximately cross-direction rigidifying component formation as illustrated in FIG. 2c. Yet another embodiment of the present invention contemplates controlled fiberization to achieve the desired rigidifying component application. One example of a controlled fiberization applicator is an air directed extrusion nozzle, such as that commercially available from Nordson Corporation, having offices in Norcross, Ga., such that the rigidifying component 12 is applied in a substantially helical or swirled fashion as illustrated in FIGS. 2 and 2a. As one skilled in the art will appreciate that the tightness or spacing of the rigidifying component may be adjusted to achieve the desired stiffness, rigidity and/or bonding. Other suitable methods of applying the rigidifying component also include, but are not limited to, spraying, slot coating, printing (such as flexographic printing), coating (such as gravure coating), extrusion, or combinations of these methods.

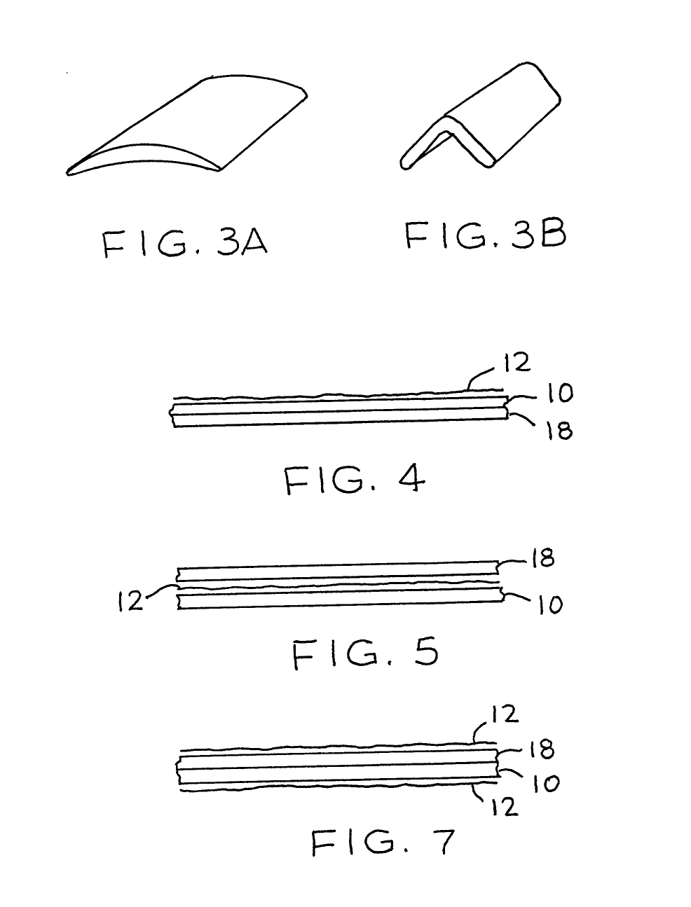

The rigidifying or stiffening component of the present invention may include a hot melt adhesive, a powder or the like. As above, the rigidifying or stiffening component may include filaments of a polymer or polymer blend, said filaments not being limited in cross-sectional shape, and having a diameter of at least about 0.0040 inches and desirably having a diameter of about 0.040 inches or larger. Desirably, at least some of the filaments of the rigidifying component or stiffening component have asymmetrical cross-sectional shapes (the diameter of which is measured at the widest points of the fiber and is an average of the diameters of the entire length of the fiber). The asymmetrical cross-sections of the filaments are selected to provide desired web stiffness or resilience and fold or pleat retention in the composite. The cross-sections of the filaments may be manipulated either during creation of the filaments or as a result of exposure to temperatures sufficient to melt at least a portion of the rigidifying or stiffness component. While the present invention is not limited in any manner to any particular filament shape, several examples of cross-sectional shapes for the filaments of contemplated for use in the invention are illustrated in FIGS. 3a and 3b. The filament shape, polymer/polymer blend and cross-directional frequency of the filaments can be optimized for the particular type of pleating (i.e. “star-wheel”, “pusher bar” and the like) used to fold the media.

Another embodiment of the present invention may further include a second nonwoven layer 18. The second layer may be positioned adjacent to the first layer 10, as shown in FIG. 4. Alternatively, as illustrated in FIG. 5, the second nonwoven layer 18 may be incorporated into the composite such that it is adjacent to the rigidifying component 12 and wherein the rigidifying component acts to adhere the first nonwoven layer 10 to the second nonwoven layer 18. As suggested above, it is contemplated that the rigidifying component may be an adhesive or at least possesses adhesive properties such as those exhibited by meltblown fibers, bicomponent fibers, some waxes or the like. Although it is desired, the rigidifying component need not be capable of adhering or bonding the nonwoven layers together as other means of bonding or adhering the nonwoven layers to each other are contemplated for those embodiments which comprise multiple nonwoven layers.

Although the composite material of the present invention is self-supporting, it is contemplated that the composite material may be incorporated into a frame, frame-like structure, or any other support means desired as a means of facilitating handling, installation or the like of the composite material.

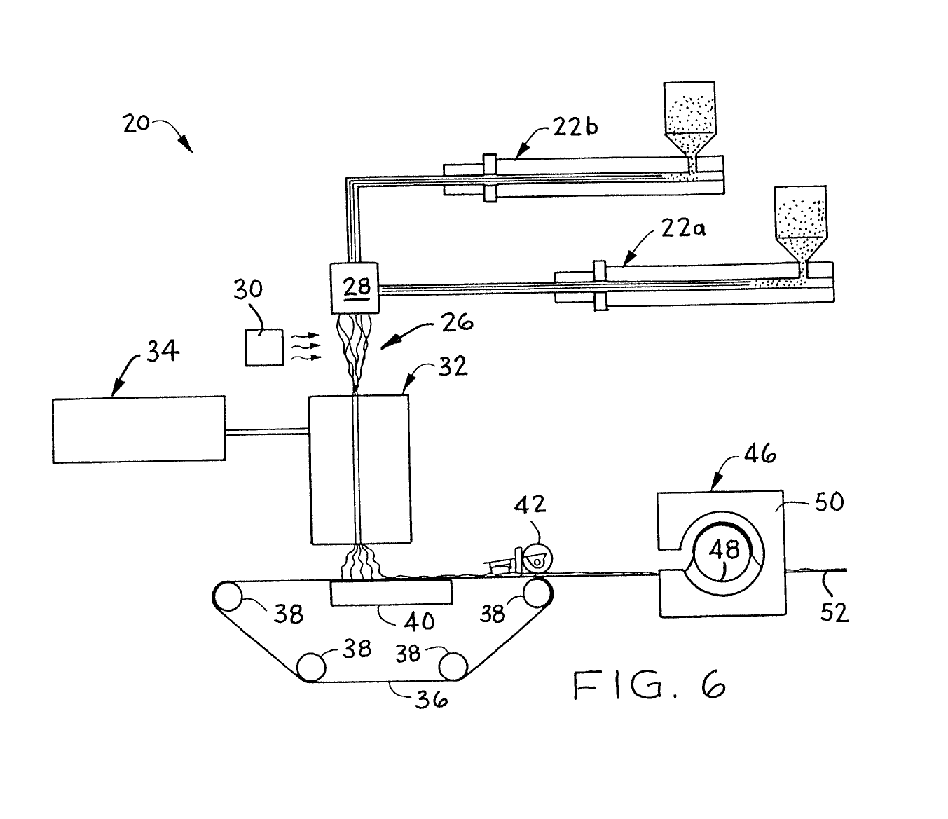

The invention is also directed to a method of producing a composite material which may be adapted for filtration. The method of the present invention includes the steps of providing a first layer of nonwoven material 10; providing a rigidifying component 12; and applying the rigidifying component 12 to the nonwoven material 10; in a manner such that the rigidifying component provides the nonwoven material with sufficient rigidity so as to create a rigid, desirably self-supporting, yet pleatable material. FIG. 6 is a schematic illustration of one operating line suitable for use in forming the composite material of the present invention.

The method of the present invention may also include the steps of providing a second layer of nonwoven material 18; applying the rigidifying component 12 to the first layer of nonwoven material 10; and applying the second layer of nonwoven material 18 to the rigidifying component 12 such that the rigidifying component 12 bonds the layers of nonwoven material together. One embodiment of the resulting product is illustrated in FIG. 5.

In another embodiment, the method of the present invention may further include the steps of providing a second layer of nonwoven material 18; and applying the second layer of nonwoven material 18 to the first nonwoven layer 10, wherein the rigidifying component 12 may be applied to either or both the first or second layer of nonwoven material. Illustrations of the alternative embodiments discussed above are shown in FIGS. 4 and 7.

The method of the present invention may also include the step of selectively applying the rigidifying component to the nonwoven material, such that when bonding occurs the filtration efficiency and pressure drop of the filter media are not adversely affected beyond that resulting from the application of the metal backing currently used. That is, the rigidifying component is desirably applied by any of a number of commercially known methods, so as to minimize the quantity of the rigidifying component which is necessary to achieve the desired resiliency and self-pleating characteristics of the present invention, yet not significantly affect the filtration characteristics of the composite beyond that resulting from the application of the metal backing currently used. The method of the present invention may also include the step of folding or pleating the media.

Turning to FIG. 6, there is illustrated a particularly suitable process 20 for producing a highly suitable spunbond fiber web for the present filter media. The process line 20 includes a pair of extruders 22a and 22b for separately supplying extruded polymer components, a high melting polymer and a low melting polymer, to a bicomponent spinneret 28, although it is contemplated that the web may be comprised of only one polymer component. The spinneret 28 has openings arranged in one or more rows, and the openings form a downwardly extending curtain of fibers when the polymers are extruded through the spinneret. For purposes of FIG. 6, the remainder of the discussion will presume that the web is comprised of bicomponent fibers.

The line 20 may further include a quenching gas outlet 30 adjacently positioned to the curtain of fibers 26 extending from the spinneret 28, and the gas from the outlet 30 at least partially quenches, i.e., the polymer forming the fibers is no longer able to freely flow. As an example, an air stream of a temperature between about 45° F. and about 90° F. which is directed substantially perpendicular to the length of the fibers at a velocity from about 100 to about 400 feet minute can be effectively used as a quenching gas. Although the quenching process is illustrated with a one-outlet quenching system, more than one quenching gas outlet can be utilized.

A fiber draw unit or an aspirator 32 is positioned below the quenching gas outlet and receives the quenched fibers. Fiber draw units or aspirators for use in melt spinning polymers are known in the art, and exemplary fiber draw units suitable for the present invention include a linear fiber aspirator of the type shown in U.S. Pat. No. 3,802,817 to Matsuki et al. and eductive guns of the type shown in U.S. Pat. Nos. 3,692,618 to Dorshner et al. and 3,423,266 to Davies et al. The fiber draw unit 32, in general, has an elongated passage through which the fibers are drawn by aspirating gas. The aspirating gas may be any gas, such as air, that does not adversely interact with the polymers of the fibers. In one embodiment of the present invention, the aspirating gas may be heated using, for example, a temperature adjustable heater 34. The heated aspirating gas draws the quenched fibers and heats the fibers to a temperature that is required to activate the latent crimps therein. The temperature required to activate the latent crimp on the fibers ranges from about 110° F to a maximum of less than the melting point of the low melting component polymer. Generally, a higher air temperature produces a higher number of crimps per linear measure of fibers. One of the advantages of the fiber web forming process described herein is that the crimp density, i.e., the number of crimps per unit length of a fiber, of the fibers and thus the density and pore size distribution of the resulting webs can be controlled by controlling the temperature of the aspirating gas, providing a convenient way to engineer nonwoven webs to accommodate different needs of different filter applications. The crimp density can also be controlled to some degree by regulating the amount of potential latent crimps that can be heat activated, and the amount of potential latent crimps can be controlled by varying the spinning conditions, e.g., melt temperature and aspirating gas velocity. For example, higher amounts of potential latent crimps can be imparted on bicomponent conjugate fibers of polyethylene/polypropylene by supplying lower velocities of aspirating gas. As noted above, the fibers need not undergo the additional crimping step, but for ease of discussion purposes below, it is presumed that the fibers are subjected to the heat activated crimping step.

The drawn crimped fibers are then deposited in a random manner onto a continuous forming surface 36, which is driven by drive rollers 38. The fiber depositing process desirably is assisted by a vacuum device 40 placed underneath the forming surface. The vacuum force largely eliminates the undesirable scattering of the fibers and guides the fibers onto the forming surface to form a uniform unbonded web of continuous fibers. The resulting web can be lightly compressed by a compression roller 42, if a light compaction of the web is desired to provide enhanced integrity to the unbonded web before the web is optionally subjected to a bonding process. Alternatively, as discussed above, a HAK can also be used to provide enhanced integrity to the unbonded web before the web is optionally subjected to a bonding process.

The unbonded web may then be bonded in a bonder, such as a through-air bonder 46, to provide coherency and physical strength. In the through-air bonder 46, a flow of heated air is applied through the web, e.g., from a hood 50 to a perforated roller 48, to heat the web to a temperature above the melting point of the low melting component polymer but below the melting point of the high melting component polymer. The bonding process may be assisted by a vacuum device that is placed underneath the perforated roller 48. Upon heating, the low melting polymer portions of the web fibers are melted and the melted portions of the fibers adhere to adjacent fibers at the cross over contact points while the high melting polymer portions of the fibers tend to maintain the physical and dimensional integrity of the web.

The bonding air temperature may vary widely to accommodate different melting points of different component polymers and to accommodate the temperature and speed limitations of different bonders. In addition, basis weight of the web must be considered in choosing the air temperature. It is to be noted that the duration of the bonding process should not be too long as to induce significant shrinkage of the web. As an example, when polypropylene and polyethylene are used as the component polymers for a conjugate-fiber web, the air flowing through the through-air bonder may have a temperature between about 230° F. and about 280° F. at a velocity from about 100 to about 500 feet per minute, and the dwell time of the web in the bonder is desirably less than about 6 seconds. It should be understood, however, that the parameters of the through-air bonder depend on factors such as the type of polymers used and thickness of the web.

Additionally, where multiple nonwoven layers are present, the through-air bonding process may be used to bond the multiple layers to one another. The through-air bonding process can also be utilized to impart a pore size gradient in the direction of thickness of the nonwoven web. A decreasing pore size gradient in a filter medium in the direction of fluid flow improves its filter efficiency and service life by systemically entrapping particulates according to their size. Alternatively stated, the upper layer of such a filter medium acts as a prefilter that systemically entraps larger particles and preserves small pores for small particles. The heated air flow rate and the vacuum flow rate can be adjusted to apply a gradually increasing, lightly compacting pressure on the nonwoven web while the web is being bonded, thereby forming an increasing fiber density gradient and a decreasing pore size gradient in the direction of thickness of the web.

In another embodiment of the present invention the nonwoven layers may be bonded to one another by thermal point bonding. Thermal point bonding may be conducted in accordance with U.S. Pat. No. 3,855,046, the disclosure of which is incorporated herein by reference. When thermal point bonded, the fabric of the present invention exhibits a more cloth-like appearance.

Although several methods of bonding the nonwoven layers have been discussed above, it should be understood that the fabric of the present invention may be bonded by other means such as oven bonding, ultrasonic bonding, or hydroentangling or combinations thereof. Such bonding techniques are well-known to those of ordinary skill in the art and are not discussed here in detail.

The step of applying the rigidifying component will occur after the formation of the nonwoven layer or layers and may be applied in-line with the production of the media or off-line. Where the rigidifying component is to be applied to an exterior surface of the composite, the rigidifying or stiffening component may be applied at any point in the process after fiber formation up to and including after the step of pleating. Where the rigidifying component is to be applied between nonwoven layers it will be apparent to one skilled in the art that this step preferably occurs prior to any pleating or folding which may occur. Furthermore, as discussed above, the rigidifying or stiffening component may be selected based on desired product characteristics, it should also be apparent that it should be selected based on processing conditions as well. That is, where it is desired to use any rigidifying component, but especially a low-low melt wax, wax blend or low-melt filament as the rigidifying component, one skilled in the art will appreciate that the rigidifying component should be capable of sustaining its form when exposed to temperatures necessary for bonding of the webs. Alternatively, one skilled in the art would recognize that if the selected rigidifying component is not capable of sustaining its form and rigidifying characteristics when exposed to the bonding temperatures, that the rigidifying component should be applied to the nonwoven layer or layers after the bonding step, but before the optional pleating or folding step.

Although much of the specification of the present invention has been discussed with regard to fibers which are crimped during formation, the present invention also contemplates that the nonwoven layers may be made with drawing techniques which produce substantially straight or non-crimped filaments.

According to another aspect of the present invention, non-multicomponent filaments or multicomponent or single component staple length fibers may be incorporated into the web. Another fabric of the present invention is made by melt spinning and drawing continuous single polymeric component filaments together with melt spinning and drawing the bicomponent polymeric filaments and incorporating the continuous single component filaments into a single web with the bicomponent filaments. This is achieved by extruding the bicomponent and single component filaments through the same spinneret. Some of the holes used in the spinneret are used to extrude bicomponent filaments while other holes in the same spinneret are used to extrude single component filaments. Preferably, the single component filaments include one of the polymers of the components of the bicomponent filaments.

According to still yet another aspect of the present invention, a multilayer nonwoven fabric is made by laminating second and third nonwoven fabric webs to a first non-woven fabric web such as is made with the process line 20 described above. Such a multilayer fabric made according to a preferred embodiment of the present invention is illustrated in FIG. 7. As can be seen, the multilayer fabric includes three layers of nonwoven fabric including multicomponent filaments having differing degrees of crimp. Advantageously, the process of the present invention can be used to produce each of such webs, and, by controlling the temperature of the mixed air in the fiber draw unit, can vary the degree of crimp between the webs. The webs may be formed separately and then laminated together or one web may be formed directly on top of another preformed web, or the webs may be formed in series, simultaneously, by placing fiber draw units in series. Although the composite fabric has three layers, it should be understood that the composite fabric of the present invention may include 2, 4, or any number of layers having different degrees of crimp.

By varying the degree of crimp from layer to layer of the fabric, the resulting fabric has a density or pore size gradient for improved liquid handling properties. For example, a multilayer fabric can be made such that the outer layer has relatively large pore sizes while the inner layer has small pore sizes so that liquid is drawn by capillary action through the more porous outer layer into the more dense inner layer. In addition, polymer type and filament denier may be altered from layer to layer to affect the liquid handling properties of the composite web.

Although the preferred method of carrying out the present invention includes contacting the multicomponent filaments with heated aspirating air, the present invention encompasses other methods of activating the latent helical crimp of the continuous filaments before the filaments are formed into a web. For example, the multicomponent filaments may be contacted with heated air after quenching but upstream of the aspirator. In addition, the multicomponent filaments may be contacted with heated air between the aspirator and the web forming surface and/or on the web forming surface itself. Furthermore, the filaments may be heated by methods other than heated air such as exposing the filaments to electromagnetic energy such as microwaves or infrared radiation.

The present invention further contemplates that the nonwoven layers may be electretized to further improve the filter efficiency. Electret treating processes suitable for the present invention are known in the art. These methods include thermal, plasma-contact, electron beam and corona discharge methods, and electretizing processes can be applied during the fiber spinning stage of the nonwoven web forming process or after the nonwoven web is fully formed. For example, U.S. Pat. No. 4,215,682 to Kubik et al. discloses an electretizing process for meltblown fibers that imparts a permanent electrostatic charge during the fiber spinning process, and U.S. Pat. No. 4,375,718 to Wadsworth et al. and U.S. patent application Ser. No. 07/958,958 filed Oct. 9, 1992, now U.S. Pat. No. 5,401,446, which is assigned to the University of Tennessee, disclose electretizing processes for fully formed nonwoven webs.

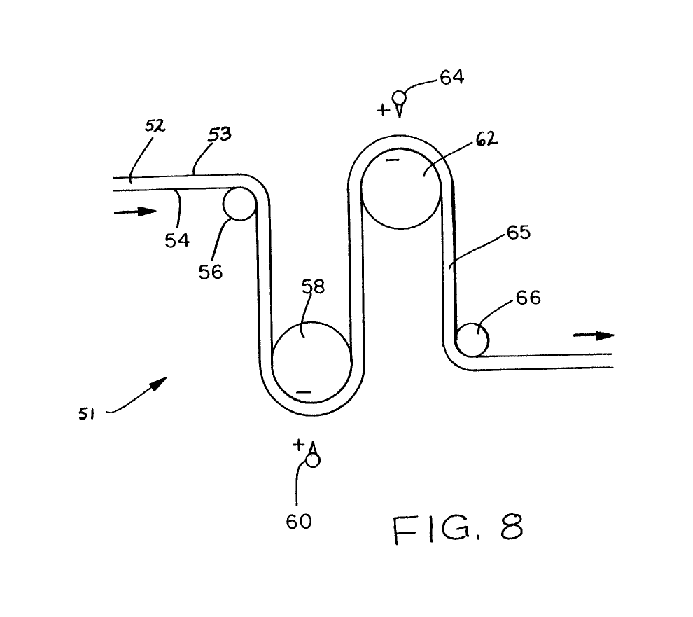

A suitable nonwoven web can be conveniently charged or electretized by sequentially subjecting the web to a series of electric fields such that adjacent electric fields have substantially opposite polarities with respect to each other. For example, one side of the web is initially subjected to a positive charge while the other side is subjected to a negative charge, and then the first side of the web is subjected to a negative charge and the other side of the web is subjected to a positive charge, imparting permanent electrostatic charges in the web. A suitable apparatus for electretizing the nonwoven web is illustrated in FIG. 8. An electretizing apparatus 51 receives a nonwoven web 52 having a first side 53 and a second side 54. The web 52 passes into the apparatus 50 with the second side 54 in contact with guiding roller 56. Then the first side 53 of the web comes in contact with a first charging drum 58 which rotates with the web 52 and brings the web 52 into a position between the first charging drum 58 having a negative electrical potential and a first charging electrode 60 having a positive electrical potential. As the web 52 passes between the charging electrode 60 and the charging drum 58, electrostatic charges are developed in the web 52. The web 52 is then passed between a negatively charged second drum 62 and a positively charged second electrode 64, reversing the polarities of the electrostatic charge previously imparted in the web and permanently imparting the newly developed electrostatic charge in the web. The electretized web 65 is then passed on to another guiding roller 66 and removed from the electretizing apparatus 50. It is to be noted that for discussion purposes, the charging drums are illustrated to have negative electrical potentials and the charging electrodes are illustrated to have positive electrical potentials. However, the polarities of the drums and the electrodes can be reversed and the negative potential can be replaced with ground. In accordance with the present invention, the charging potentials useful for electretizing processes may vary with the field geometry of electretizing processes. For example, the electric fields for the above-described electretizing process can be effectively operated between about 1 KVDC/cm and about 30 KVDC/cm, desirably between about 4 KVDC/cm and about 20 KVDC/cm, when the gap between the drum and the electrodes is about 0.9 inches. The above-described suitable electretizing process is further disclosed in above-mentioned U.S. Pat. No. 5,401,446, which is herein incorporated by reference.

As a desired embodiment of the present invention, the nonwoven web forming process and the electretizing process are conducted in a continuous in-line process, although the two processes can be conducted separately in sequence. The present invention contemplates that the step of electretizing may occur before or after the application of the rigidifying or stiffening component.

The filter efficiency of the filter media can be even further improved by utilizing shaped fibers that have a higher fiber surface area than conventional round fibers and/or a cross-sectional shape that allows the fibers to form a filter medium which has slender interfiber pore configurations. Such filter media having a higher fiber surface area and improved pore configurations provide higher filter efficiencies. Particularly useful cross-sectional shapes suitable for the present conjugate fibers include rectangular, oblong, triangular, trilobal and other multilobal shapes.

The present filter media provide a high filter efficiency that is comparable to that of microfiber filter media without the high pressure drop of microfiber filter media. In addition, the present crimped fiber filter media provide highly improved service life, filter capacity and self-supporting physical integrity and strength. In addition, the filter media, especially the media produced from conjugate fibers, are highly thermoformable. When the filter media are heated to a temperature within the above-described bonding range, in which only the lowest melting component polymer is melted, the media can be easily thermoformed without applying any significant compacting pressure and thus preserving the advantageous loft of the media. For example, the filter media can be thermoformed to a pleat to enhance physical strength and to increase the effective filtration area. A thermoforming processes suitable for the nonwoven web for the filter media is disclosed in commonly assigned U.S. patent application Ser. No. 08/176,594 filed Jan. 3, 1994 and related European Patent 0665315 granted Feb. 9, 2000, which are herein incorporated by reference. Briefly and nonexhaustively described, the thermoforming process contains the steps of heating a fully formed conjugate fiber web to melt the lowest component polymer of the web, e.g., using a through-air heating process; applying a minimal pneumatic or mechanical shaping pressure on the heated web to make the web conform to the contour of a mold; cooling the web to a temperature below the melting temperature of the lowest melting polymer while maintaining the shaping pressure.

Additionally, the nonwoven web for the present filter media may contain additives and other fibers known to enhance the performance of filter media. For example, the nonwoven web may contain within its fiber matrix particulates of odor and/or chemical absorbent particles, e.g., activated carbon; filler and bulking fibers; germicides; disinfectants and the like. In addition, the fibers forming the filter media may contain conventional additives, such as, heat-stabilizers, fillers, UV-stabilizers, pigments and the like.

As noted above the present invention may further include the step of pleating or folding the composite which has been produced. It is generally desirable that the pleating of the composite occur after the application of the rigidifying or stiffening component; however, where multiple nonwoven layers are included in the composite, the nonwoven layers should be bound to one another prior to pleating.

### EXAMPLE

As indicated above, a number of different embodiments are contemplated by the present invention. One exemplary embodiment of the present invention is as follows: a sealing wax, available from Yaley Enterprises, Redding, Calif. 96002, (Item No. 110805), was melted in a metal dispenser at approximately 170° F. The wax was then manually dispensed onto INTREPID® 353H filter media (a non-pleatable filter media unless reinforced) (available from Kimberly-Clark Corporation, having offices in Roswell, Ga.) by pouring the wax onto the media while moving the dispenser in a linear manner to create a line of wax on the media. This line creation step was repeated to create a diamond shaped pattern of wax lines on the media having line width of approximately 0.19″ and a wax thickness of approximately 0.06″. Spacing between the wax lines of the diamond pattern was approximately 2″. After the wax had cooled to ambient temperature, the resulting wax rigidified filter media was then pleated by hand and assembled into a filter frame.

While the present invention has been described in connection with certain desired embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

It should further be noted that any patents, applications or publications referred to herein are incorporated by reference in their entirety.

What is claimed is:

1. A composite structure comprising:
a first nonwoven layer, having a first surface and a second surface opposite the first surface; and
a rigidifying component applied to one surface of the nonwoven layer;
wherein the rigidifying component provides sufficient stiffness to the composite such that the structure can be self-pleatable yet maintain flexibility.

2. The composite of claim 1, wherein the rigidifying component comprises filaments of a polymer or polymer blend, said filaments having a cross-sectional shape.

3. The composite of claim 1, wherein the rigidifying component comprises polymer filaments having a diameter of at least about 0.004 inches.

4. The composite of claim 1, wherein the rigidifying component comprises polymer filaments having a diameter of about 0.040-0.12 inches.

5. The composite of claim 1, wherein the rigidifying component comprises a wax or blend.

6. The composite of claim 1, wherein the rigidifying component further includes a filler material.

7. The composite of claim 1, wherein the rigidifying component contains filler in an amount between about 10 to about 80% by weight.

8. The composite of claim 1, wherein the rigidifying component contains filler in an amount between about 30 to about 50% by weight.

9. The composite of claim 1, wherein the rigidifying component is selectively applied to the structure.

10. The composite of claim 1, wherein the structure further comprises a second nonwoven layer.

11. The composite of claim 10, wherein the second nonwoven layer is positioned adjacent to the first layer.

12. The composites of claim 10, wherein the second nonwoven layer is adjacent to the rigidifying component wherein the rigidifying component adheres the first nonwoven layer to the second nonwoven layer.

13. The composite of claim 1, wherein the rigidifying component is an adhesive.

14. The composite of claim 1, wherein the nonwoven layers are comprised of a spunbond web, bicomponent spunbond web, meltblown web, coformed web or bonded carded web.

15. The composite of claim 2, wherein the filaments of the nonwoven layers have a variety of cross-sectional shapes.

16. The composite of claim 15, wherein at least some of the filaments have asymmetrical cross-sectional shapes.

17. The composite of claim 15, wherein the filaments having asymmetrical cross-sectional shapes are selected to provide desired web stiffness and fold retention in the composite.

18. The composite of claim 1, wherein the composite is a filter media.

19. A filter media comprising:
a first layer of nonwoven material; and
a stiffening component, said stiffening component applied to the material;
wherein the filter media is self-pleatable; and
wherein the stiffening component provides sufficient resilience to the filter media to maintain the pleats.

20. The filter media of claim 19, further comprising a second layer of nonwoven material.

21. The filter media of claim 19, wherein the rigidifying component comprises filaments of a polymer or polymer blend, said filaments having a cross-sectional shape.

22. The filter media of claim 19, wherein the rigidifying component comprises a wax or blend.

23. The filter media of claim 19, wherein the rigidifying component further includes a filler material.

24. The filter media of claim 20, wherein the stiffening component is applied between the first and second layer of the nonwoven material so as to permit bonding of the layers, and wherein the stiffening component provides for bonding between the first layer of nonwoven material and the second layer of nonwoven material.

25. The media of claim 20, wherein the first and second nonwoven layers are adjacent to each other and the stiffening component is applied to either the first or the second nonwoven layer.

26. The filter media of claim 19, wherein the stiffening component is selectively applied to provide the necessary bonding and to minimize the effect of the stiffening component on the filtration efficiency and pressure drop of the media.

27. The filter media of claim 19, wherein the nonwoven layers are comprised of a spunbond web, bicomponent spunbond, meltblown web, coformed web or bonded carded web.

28. A method for forming a composite material adapted for uses such as a filtration media, said method comprising:
providing a first layer of nonwoven material, the first layer having a first surface and a second surface;
providing a rigidifying component; and
applying the rigidifying component to the nonwoven material;
wherein the rigidifying component bonds to the nonwoven material together so as to create a rigid media.

29. The method of claim 28, wherein the method further comprises the step of providing a second layer of nonwoven material.

30. The method of claim 29, wherein the method further comprises the step of applying the second layer of nonwoven material to the rigidifying component.

31. The method of claim 29, wherein the method further comprises the step of applying the second layer of nonwoven material to the first nonwoven layer.

32. The method of claim 29, wherein the between the steps of providing a first layer of nonwoven material and the step of applying the rigidifying component to the nonwoven material, the method further comprises the steps of:
providing a second layer of nonwoven material; and
applying the applying the second layer of nonwoven material to the first nonwoven layer;
wherein the rigidifying component may be applied to either the first or second layer of nonwoven material.

33. The method of claim 30, where in the rigidifying component bonds the layers of the nonwoven material together.

34. The method of claim 28, wherein the method further comprises selectively applying the rigidifying component to the nonwoven material, such that when bonding occurs the filtration efficiency and pressure drop of the composite material is not adversely affected.

35. The method of claim 28, wherein the method further comprises the step of folding or pleating the composite material.

36. The method of claim 29, wherein the step of providing the first layer of nonwoven material further comprises in-line or off-line formation of the first layer.

37. The method of claim 29, wherein the step of providing the second layer of nonwoven material further comprises in-line or off-line formation of the second layer.

38. The method of claim 28, wherein the composite material comprises a filter media product or component thereof.
